(19) United States
(12) Patent Application Publication
(10) Pub. No.: US 2022/0174348 A1
(43) Pub. Date: Jun. 2, 2022

(54) Media playback apparatus and method having audio channel automatic selection mechanism

(71) Applicant: REALTEK SEMICONDUCTOR CORPORATION, Hsinchu (TW)

(72) Inventor: WEI-HAO CHEN, Hsinchu (TW)

(21) Appl. No.: 17/530,485

(22) Filed: Nov. 19, 2021

(30) Foreign Application Priority Data
Dec. 2, 2020 (TW) 109142419

(51) Int. Cl. H04N 21/439; H04N 21/485; H04N 21/472

(52) U.S. Cl. CPC H04N 21/4394; H04N 21/47217; H04N 21/4852

(57) ABSTRACT

The present invention discloses a media playback apparatus having audio channel automatic selection mechanism that includes a communication circuit, a storage circuit and a processing circuit. The storage circuit stores computer executable commands The processing circuit executes the computer executable commands to execute a media playback method that includes the steps outlined below. An audio signal of a program corresponding to a channel is started to be received through the communication circuit. A detection module is operated to determine whether a supported audio channel mode of the audio signal is different from a previous supported audio channel mode. When the supported audio channel mode is different from the previous supported audio channel mode, a mode option is selected from at least one audio channel mode option supported by the audio channel mode according to a predetermined preference order. The audio signal is playback according to the selected mode option.

### BACKGROUND OF THE INVENTION

### 1. Field of the Invention

The present invention relates to a media playback apparatus and method having audio channel automatic selection mechanism.

### 2. Description of Related Art

Different channels and programs may support different audio channels due to the playback ability of the media playback apparatus or the user's preference when a media is to be played. Different transmission methods may be used according to the audio transmission standard that the audio signal corresponds to, and the supported audio channel modes may be different in different programs.

In conventional technologies, the media playback apparatus needs to use hardware circuit, such as but not limited to a decoder, to detect the analog signal so as to select a predetermined audio channel mode or select the audio channel mode manually by the user. Not only the manufacturer of the apparatus needs to take addition cost to dispose the hardware, but also the audio channel options can not be selected in a more elastic way.

### SUMMARY OF THE INVENTION

In consideration of the problem of the prior art, an object of the present invention is to supply a media playback apparatus and method having audio channel automatic selection mechanism.

The present invention discloses a media playback apparatus having audio channel automatic selection mechanism that includes a communication circuit, a storage circuit and a processing circuit. The storage circuit is configured to store computer executable commands The processing circuit is configured to execute the computer executable commands, to execute a media playback method that includes the steps outlined below. An audio signal corresponding to a program of a channel is started to receive through the communication circuit. A detection module is operated to determine whether a supported audio channel mode of the audio signal is different from a previous supported audio channel mode. A mode option is selected from at least one audio channel mode option supported by the audio channel mode according to a predetermined preference order when the supported audio channel mode is different from the previous supported audio channel mode. The audio signal is played according to the selected mode option.

The present invention also discloses a media playback method having audio channel automatic selection mechanism used in a media playback apparatus that includes the steps outlined below. An audio signal corresponding to a program of a channel is started to receive through a communication circuit by a processing circuit. A detection module is operated to determine whether a supported audio channel mode of the audio signal is different from a previous supported audio channel mode by the processing circuit. A mode option is selected from at least one audio channel mode option supported by the audio channel mode according to a predetermined preference order when the supported audio channel mode is different from the previous supported audio channel mode by the processing circuit. The audio signal is played according to the selected mode option by the processing circuit.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 illustrates a diagram of a media playback apparatus having audio channel automatic selection mechanism according to an embodiment of the present invention.

FIG. 2 illustrates a flow chart of a media playback method according to an embodiment of the present invention.

### DETAILED DESCRIPTION OF THE PREFERRED EMBODIMENTS

An aspect of the present invention is to provide a media playback apparatus and method having audio channel automatic selection mechanism to automatically detect the audio transmission standard and the supported audio channel mode of the audio signal by using software, such that an audio channel mode option is selected automatically when the supported audio channel mode is different to play the audio signal without the use of additional hardware circuit. The selection of the audio channel mode option can be more elastic.

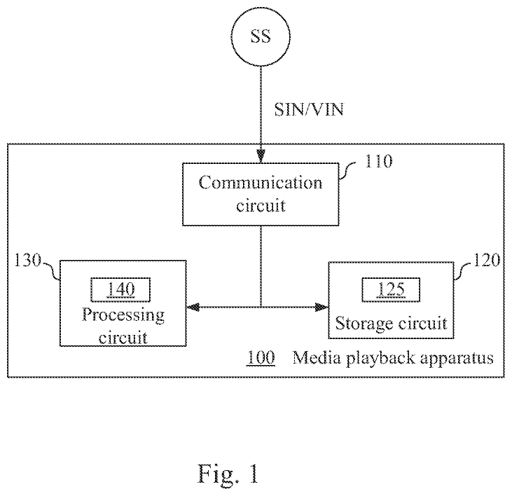

Reference is now made to FIG. 1. FIG. 1 illustrates a diagram of a media playback apparatus 100 having audio channel automatic selection mechanism according to an embodiment of the present invention. The media playback apparatus 100 includes a communication circuit 110, a storage circuit 120 and a processing circuit 130.

The communication circuit 110 can by any circuit configured to perform communication with a remote signal source SS through either wireless or wired communication technologies.

The storage circuit 120 can be any storage device configured to store data, such as but not limited to a random access memory (RAM), a read only memory (ROM) or a hard disk. It is appreciated that in different embodiments, the storage circuit 120 may include only one of the storage devices described above, or include a plurality of the storage devices described above to store different types of data. In an embodiment, the storage circuit 120 is configured to store computer executable commands 125.

The processing circuit 130 is electrically coupled to the communication circuit 110 and the storage circuit 120. In an embodiment, the processing circuit 130 is configured to retrieve and execute the computer executable commands 125 from the storage circuit 120. The computer executable commands 125 include such as, but not limited to firmware/driver or related commands of hardware modules such as the communication circuit 110 and the storage circuit 120, to access the signal or data of the communication circuit 110 and the storage circuit 120 to perform operation to further execute the function of the media playback apparatus 100.

The operation of the media playback apparatus 100 is further described in detail in the following paragraphs.

The processing circuit 130 starts to receive an audio signal SIN corresponding to a program of a channel through the communication circuit 110 from the signal source SS described above.

In an embodiment, the processing circuit 130 can actually receive a program signal that includes a video signal VIN and the audio signal SIN through the communication circuit 110 from the signal source SS, to play the video signal VIN and the audio signal SIN simultaneously after these signals are processed.

The processing circuit 130 operates the detection module 140 to determine the channel, the program and the modes supported by the program corresponding to the audio signal SIN, to further determine how to play the audio signal SIN based on the determine result. In an embodiment, the detection module 140 is application program software configured to perform determination on the audio signal SIN. In an embodiment, the detection module 140 is a software module generated by the processing circuit 130 after the computer executable commands 125 are executed.

In an embodiment, at first, the processing circuit 130 determines whether a supported audio channel mode of the audio signal is different from a previous supported audio channel mode. More specifically, the processing circuit 130 determines whether a user switches the channel When the current channel is different from the previous channel, the processing circuit 130 resets the detection module 140, to perform the operation of such as, but not limited removing parameters related to the operation of the detection module 140. The parameters described above can be stored in such as, but not limited to internal or external registers of the media playback apparatus 100.

When the current channel is the same as the previous channel, or when the detection module 140 is reset under the condition that the current channel is different from the previous channel, the processing circuit 130 operates the detection module 140 to detect the audio transmission standard that the channel corresponds to. When the transmission of the audio signal is performed under different audio transmission standards, different frequency allocation methods are used. In an embodiment, the audio transmission standard can be such as, but not limited to one of A2, NICAM and FM.

In an embodiment, the processing circuit 130 detects that whether the channel corresponds to one of NICAM, A2 and FM in series. When the audio transmission standard that the channel corresponds to is not detected successfully, the detection is kept performing until a detection result is generated. However, the present invention is not limited thereto.

The processing circuit 130 operates the detection module 140 to determine whether the supported audio channel mode of the audio signal SIN is different from the previous supported audio channel mode under the detected audio transmission standard. Under different audio transmission standards, the audio signal SIN may correspond to different supported audio channel modes. Further, different supported audio channel modes may include different audio channel mode options.

In an embodiment, when the audio transmission standard is A2, the supported audio channel mode is one of a mono mode, a stereo mode and a secondary audio program (SAP) mode. The audio channel mode option included in the mono mode is a mono option. The audio channel mode options included in the stereo mode are the mono option and a stereo option. The audio channel mode options included in the secondary audio program mode are the mono option, the stereo option and a secondary audio program option.

In an embodiment, when the audio transmission standard is one of NICAM and FM, the supported audio channel mode is one of a mono mode, a stereo mode and a dual mode. The audio channel mode option included in the mono mode is a mono option. The audio channel mode options included in the stereo mode are the mono option and a stereo option. The audio channel mode options included in the dual mode are the mono option, the stereo option and at least one language option. The number of the language option can be determined by the language channels supported by the program.

When the supported audio channel mode is different from the previous supported audio channel mode, the processing circuit 130 selects a mode option from the audio channel mode option(s) supported by the supported audio channel mode according to a predetermined preference order.

In an embodiment, the predetermined preference order is configured to make the processing circuit 130 select the audio channel mode option that the user prefers from the audio channel mode option supported by the audio channel mode first. In an embodiment, the audio channel mode option that the user prefers can be an audio channel mode option that the user manually selected last time, or an audio channel mode option that is selected most in the playback history of the user. The present invention is not limited thereto.

When the audio channel mode option that the user prefers does not exist, the processing circuit 130 selects one of the other audio channel mode options that the supported audio channel mode supports. In an embodiment, when the audio transmission standard is A2, the predetermined preference order can be used to make the processing circuit 130 to perform selection in a priority order of a stereo option, a mono option, a secondary audio program option and a language option supported by the audio channel mode when the audio channel mode option that the user prefers does not exist. In another embodiment, when the audio transmission standard is one of NICAM and FM, the predetermined preference order can be used to make the processing circuit 130 to perform selection in a priority order of a stereo option, a mono option and a language option when the audio channel mode option that the user prefers does not exist.

On the contrary, when the supported audio channel mode is the same as the previous supported audio channel mode, the processing circuit 130 selects the audio channel mode option that is selected under the previous supported audio channel mode to play the audio signal SIN.

Subsequently, the processing circuit 130 plays the audio signal SIN according to the selected audio channel mode option. In an embodiment, the processing circuit 130 actually plays the video signal VIN and the audio signal SIN simultaneously.

A usage scenario is used as an example in the following paragraphs to further describe the operation of the media playback apparatus 100.

For example, in a usage scenario, the processing circuit 130 receives a signal corresponding to a single channel having the audio transmission standard of A2 from the signal source SS. Different programs of such a channel is played in a first time interval, a second time interval and a third time interval respectively. The processing circuit 130 operates the detection module 140 to detect that the supported audio channel mode of each of the programs is the secondary audio program mode, the stereo mode and the secondary audio program mode in the first time interval, the second time interval and the third time interval respectively.

The user manually selects the secondary audio program option to play the audio signal SIN in the first time interval. As a result, the secondary audio program option becomes the audio channel mode option that the user prefers in the predetermined preference order.

However, for the second time interval, the processing circuit 130 performs selection in a priority order of the stereo option and the mono option according to the predetermined preference order since the secondary audio program option is absent in the stereo mode. As a result, the processing circuit 130 automatically selects the stereo option to play the audio signal SIN since the stereo option is presented in the stereo mode.

Subsequently, for the third time interval, the processing circuit 130 selects the audio channel mode option that the user prefers, i.e., the secondary audio program option, according to the predetermined preference order to play the audio signal SIN since the secondary audio program option is presented in the secondary audio program mode.

As a result, the media playback apparatus having audio channel automatic selection mechanism can automatically detect the audio transmission standard and the supported audio channel mode of the audio signal by using software, such that an audio channel mode option is selected automatically when the supported audio channel mode is different to play the audio signal without the use of additional hardware circuit. The selection of the audio channel mode option can be more elastic.

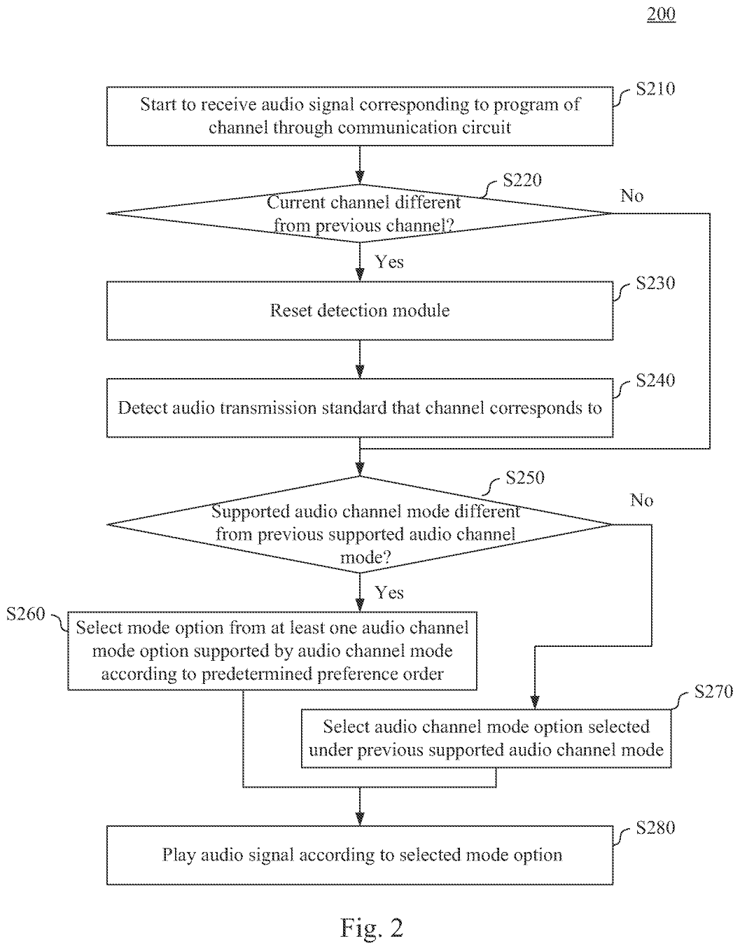

Reference is now made to FIG. 2. FIG. 2 illustrates a flow chart of a media playback method 200 according to an embodiment of the present invention.

In addition to the apparatus described above, the present disclosure further provides the media playback method 200 that can be used in such as, but not limited to, the media playback apparatus 100 in FIG. 1. As illustrated in FIG. 2, an embodiment of the media playback method 200 includes the following steps.

In step S210, the audio signal SIN corresponding to a program of a channel is started to receive through the communication circuit 110 by the processing circuit 130.

In step S220, whether the current channel is different from a previous channel is determined by the processing circuit 130.

In step S230, the detection module 140 is reset when the current channel is different from the previous channel

In step S240, the detection module 140 is operated to detect the audio transmission standard that the channel corresponds to by the processing circuit 130.

In step S250, the detection module 140 is operated to determine whether the supported audio channel mode of the audio signal SIN is different from the previous supported audio channel mode by the processing circuit 130 when the current channel is determined to be the same as the previous channel in step S220 or when the audio transmission standard that the channel corresponds to is determined.

In step S260, the mode option is selected from at least one audio channel mode option supported by the audio channel mode according to a predetermined preference order when the supported audio channel mode is different from the previous supported audio channel mode by the processing circuit.

In step S270, the audio channel mode option that is selected under the previous supported audio channel mode is selected by the processing circuit 130 when the supported audio channel mode and the previous supported audio channel mode are the same.

In step S280, the audio signal SIN is played according to the selected mode option by the processing circuit 130 after the audio channel mode option is finished being selected in step S260 and step S270.

It is appreciated that the embodiments described above are merely an example In other embodiments, it should be appreciated that many modifications and changes may be made by those of ordinary skill in the art without departing, from the spirit of the invention.

In summary, the media playback apparatus and method having audio channel automatic selection mechanism can automatically detect the audio transmission standard and the supported audio channel mode of the audio signal by using software, such that an audio channel mode option is selected automatically when the supported audio channel mode is different to play the audio signal without the use of additional hardware circuit. The selection of the audio channel mode option can be more elastic.

The aforementioned descriptions represent merely the preferred embodiments of the present invention, without any intention to limit the scope of the present invention thereto. Various equivalent changes, alterations, or modifications based on the claims of present invention are all consequently viewed as being embraced by the scope of the present invention.

What is claimed is:

1. A media playback apparatus having audio channel automatic selection mechanism, comprising:
a communication circuit;
a storage circuit configured to store computer executable commands; and
a processing circuit configured to execute the computer executable commands, to execute a media playback method comprising:
starting to receive an audio signal corresponding to a program of a channel through the communication circuit;
operating a detection module to determine whether a supported audio channel mode of the audio signal is different from a previous supported audio channel mode;
selecting a mode option from at least one audio channel mode option supported by the audio channel mode according to a predetermined preference order when the supported audio channel mode is different from the previous supported audio channel mode; and
playing the audio signal according to the selected mode option.

2. The media playback apparatus of claim 1, wherein the media playback method further comprises:
resetting the detection module when the channel is different from a previous channel

3. The media playback apparatus of claim 2, wherein the media playback method further comprises:
operating the detection module to detect an audio transmission standard corresponding to the channel so as to determine the supported audio channel mode under the detected audio transmission standard.

4. The media playback apparatus of claim 3, wherein the audio transmission standard is A2 and the supported audio channel mode is one of a mono mode, a stereo mode and a secondary audio program (SAP) mode, in which the audio channel mode option comprised in the mono mode is a mono option, the audio channel mode options comprised in the stereo mode are the mono option and a stereo option, and the audio channel mode options comprised in the secondary audio program mode are the mono option, the stereo option and a secondary audio program option.

5. The media playback apparatus of claim 3, wherein the audio transmission standard is one of NICAM and FM, and the supported audio channel mode is one of a mono mode, a stereo mode and a dual mode, in which the audio channel mode option comprised in the mono mode is a mono option, the audio channel mode options comprised in the stereo mode are the mono option and a stereo option, and the audio channel mode options comprised in the dual mode are the mono option, the stereo option and at least one language option.

6. The media playback apparatus of claim 1, wherein the step of selecting the mode option from the audio channel mode option supported by the audio channel mode according to the predetermined preference order when the supported audio channel mode is different from the previous supported audio channel mode further comprises:
selecting the audio channel mode option that a user preferred from the audio channel mode option supported by the audio channel mode first; and
selecting one of the other audio channel mode option supported by the audio channel mode when the audio channel mode option that the user prefers does not exist.

7. The media playback apparatus of claim 6, wherein the media playback method further comprises:
performing selection in a priority order of a stereo option, a mono option, a secondary audio program option and a language option supported by the audio channel mode when the audio channel mode option that the user prefers does not exist.

8. The media playback apparatus of claim 1, wherein the media playback method further comprises:
starting to receive a video signal corresponding to the channel through the communication circuit; and
playing the video signal and audio signal simultaneously.

9. The media playback apparatus of claim 1, wherein the media playback method further comprises:
selecting the audio channel mode option that is selected under the previous supported audio channel mode when the supported audio channel mode and the previous supported audio channel mode are the same to play the audio signal.

10. A media playback method having audio channel automatic selection mechanism used in a media playback apparatus, comprising:
starting to receive an audio signal corresponding to a program of a channel through a communication circuit by a processing circuit;
operating a detection module to determine whether a supported audio channel mode of the audio signal is different from a previous supported audio channel mode by the processing circuit;
selecting a mode option from at least one audio channel mode option supported by the audio channel mode according to a predetermined preference order when the supported audio channel mode is different from the previous supported audio channel mode by the processing circuit; and
playing the audio signal according to the selected mode option by the processing circuit.

11. The media playback method of claim 1, further comprising:
resetting the detection module when the channel is different from a previous channel by the processing circuit.

12. The media playback method of claim 2, wherein the media playback method further comprises:
operating the detection module to detect an audio transmission standard corresponding to the channel so as to determine the supported audio channel mode under the detected audio transmission standard.

13. The media playback method of claim 12, wherein the audio transmission standard is A2 and the supported audio channel mode is one of a mono mode, a stereo mode and a secondary audio program (SAP) mode, in which the audio channel mode option comprised in the mono mode is a mono option, the audio channel mode options comprised in the stereo mode are the mono option and a stereo option, and the audio channel mode options comprised in the secondary audio program mode are the mono option, the stereo option and a secondary audio program option.

14. The media playback method of claim 12, wherein the audio transmission standard is one of NICAM and FM, and the supported audio channel mode is one of a mono mode, a stereo mode and a dual mode, in which the audio channel mode option comprised in the mono mode is a mono option, the audio channel mode options comprised in the stereo mode are the mono option and a stereo option, and the audio channel mode options comprised in the dual mode are the mono option, the stereo option and at least one language option.

15. The media playback method of claim 10, wherein the step of selecting the mode option from the audio channel mode option supported by the audio channel mode according to the predetermined preference order when the supported audio channel mode is different from the previous supported audio channel mode further comprises:
selecting the audio channel mode option that a user preferred from the audio channel mode option supported by the audio channel mode first by the processing circuit; and
selecting one of the other audio channel mode option supported by the audio channel mode by the processing circuit when the audio channel mode option that the user prefers does not exist.

16. The media playback method of claim 15, further comprising:
performing selection in a priority order of a stereo option, a mono option, a secondary audio program option or a language option supported by the audio channel mode by the processing circuit when the audio channel mode option that the user prefers does not exist.

17. The media playback method of claim 10, further comprising:
starting to receive a video signal corresponding to the channel through the communication circuit by the processing circuit; and
playing the video signal and audio signal simultaneously by the processing circuit.

18. The media playback method of claim 10, further comprising:
selecting the audio channel mode option that is selected under the previous supported audio channel mode when the supported audio channel mode and the previous supported audio channel mode are the same to play the audio signal by the processing circuit.
